(19) United States
(12) Patent Application Publication
(10) Pub. No.: US 2013/0159077 A1
(43) Pub. Date: Jun. 20, 2013

(54) LOCAL AFFILIATE MARKETING

(71) Applicants: Westley Martin Stringfellow, Los Gatos, CA (US); Donald Kingsborough, Danville, CA (US)

(72) Inventors: Westley Martin Stringfellow, Los Gatos, CA (US); Donald Kingsborough, Danville, CA (US)

(73) Assignee: EBAY, INC., San Jose, CA (US)

(21) Appl. No.: 13/330,089

(22) Filed: Dec. 19, 2011

(51) Int. Cl. G06Q 30/02

(52) U.S. Cl. 705/14.16; 705/14.38; 705/14.25

(57) ABSTRACT

Merchants within close proximity to each other are “affiliated” with other by distance. A consumer making a first purchase at a first affiliated merchant is provided coupons or other incentives to make a second purchase with one or more other affiliated merchants. The consumer may pre-pay for the second purchase at the first affiliated merchant. A payment provider may debit an account of the first affiliated merchant the amount of the second purchase minus any amount due to the first affiliated merchant as a result of the second purchase. An account of the second affiliated merchant offering the incentive may be credited accordingly. The consumer and/or the affiliated merchant offering the incentive may be notified so that the consumer can simply go to the affiliated merchant to pick up the purchase, such as by showing proof of purchase or an identifier.

### BACKGROUND

1. Field of the Invention

The present invention is related generally to local merchant marketing and more particularly to providing incentives for use at local merchants when a consumer is at a local, but unrelated merchant.

2. Description of Related Art

As online shopping and purchasing have increased, consumers are shopping less at physical brick and mortar stores. However, while online shopping has its advantages, such as convenience, many consumers may still prefer to shop at a physical point of sale (POS). Reasons may include the excitement or experience of the traditional shopping experience, being able to see, feel, hold, or try on items for possible purchase, asking questions to sales persons, etc.

To take full advantage of shoppers when they shop at physical stores, merchants may group themselves together so that the shopper can easily move from store to store, thereby reducing the inconvenience or deterrent of getting into a car and driving to another shopping location. This is one reason that malls are still thriving, from smaller strip malls to mega shopping malls.

One example of typical mall shopping is that the consumer goes to the mall to shop specifically at one store in the mall. While at the mall, the consumer may walk around and stop by different stores to browse. The consumer may end up purchasing from different stores for various reasons, including seeing a sale or other good deal on an item.

Thus, even though the consumer went to the mall for a specific merchant or store, other stores may benefit from a sale due to the specific merchant. Ideally, this benefits all the stores in the mall equally, but in reality, a popular store may not benefit as much because more consumers will intend to make a purchase at the popular store, but the popular store may not get many purchases from consumers going to the mall for other less popular stores.

Therefore, there is a need for stores to be able to obtain additional sales or revenue as being a part of a group of stores that are physically close to each other.

### SUMMARY

According to one embodiment of the present invention, merchants within close proximity to each other are “affiliated” with other by distance as opposed to a company affiliation. A consumer making a first purchase at a first affiliated merchant is provided coupons or other incentives to make a second purchase at one or more other affiliated merchants. The consumer may pre-pay for the second purchase at the first affiliated merchant. A payment provider may debit an account of the first affiliated merchant the amount of the second purchase minus any amount due to the first affiliated merchant as a result of the second purchase. An account of the second affiliated merchant offering the incentive may be credited accordingly. The consumer and/or the affiliated merchant offering the incentive may be notified so that the consumer can simply go to the affiliated merchant to pick up the purchase, such as by showing proof of purchase or an identifier.

In one embodiment, the consumer need not make the purchase at the first merchant, but may instead present the incentive to the second affiliated merchant and make the purchase at the second affiliated merchant. In this case, the payment provider may credit the second affiliated merchant account with the purchase price minus any amount due to the first affiliated merchant for presenting the incentive. The first affiliated merchant account may then be credited with the referral amount.

In another embodiment, the payment provider provides consumer-specific incentives based on previous transactions by the consumer. This increases the likelihood that the consumer will use the incentive to make a purchase, as well as not overwhelm the consumer with incentives likely to be of little or no interest to the consumer.

As a result, merchants in proximity with each other may be affiliated by location so that they can increase likelihood of sales of those merchants by offering incentives, such as consumer-specific incentives, to consumers making a purchase at any local merchant, where the incentives are available for use at other local merchants. This local marketing may then achieve increased sales for all merchants in the local affiliation.

These and other features and advantages of the present invention will be more readily apparent from the detailed description of the embodiments set forth below taken in conjunction with the accompanying drawings.

### BRIEF DESCRIPTION OF THE DRAWINGS

FIG. 1 is a flowchart of a method local merchant marketing according to one embodiment;

FIG. 2 show various examples of local merchant groupings according to one embodiment;

FIG. 3 is block diagram of a networked system suitable for implementing the processes described herein according to an embodiment; and

FIG. 4 is a block diagram of a computer system suitable for implementing one or more components in FIG. 3 according to one embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

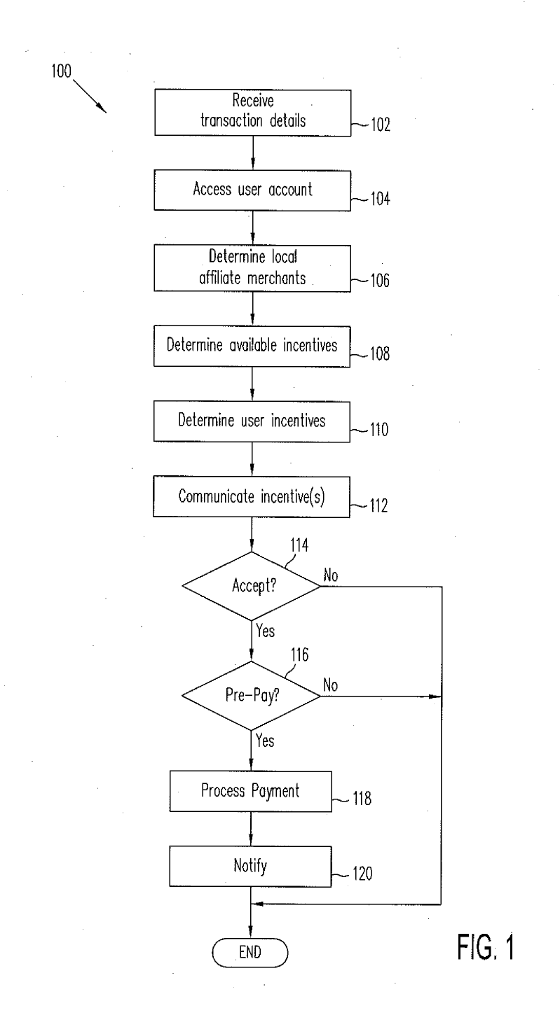

FIG. 1 is a flowchart 100 of a method for local merchants to market to other local merchants, where the merchants are affiliated by location, according to one embodiment. At step 102, a service or payment provider, such as PayPal, Inc. of San Jose, Calif., receives transaction details from a first local merchant. “Local” merchants are defined, in one embodiment, as merchants located within a certain proximity of each other and may be based on a type of grouping. For example, merchants within a five-store “mall” may be all local to each other, and merchants within a 100-store mega mall may also be all local to each other. In one embodiment, “local” is confined to merchants within a specific grouping. There may also be local merchants as a sub-group within a larger local merchant group. In another embodiment, a local group of merchants is defined by how far the group is separated from the next merchant or group of merchants.

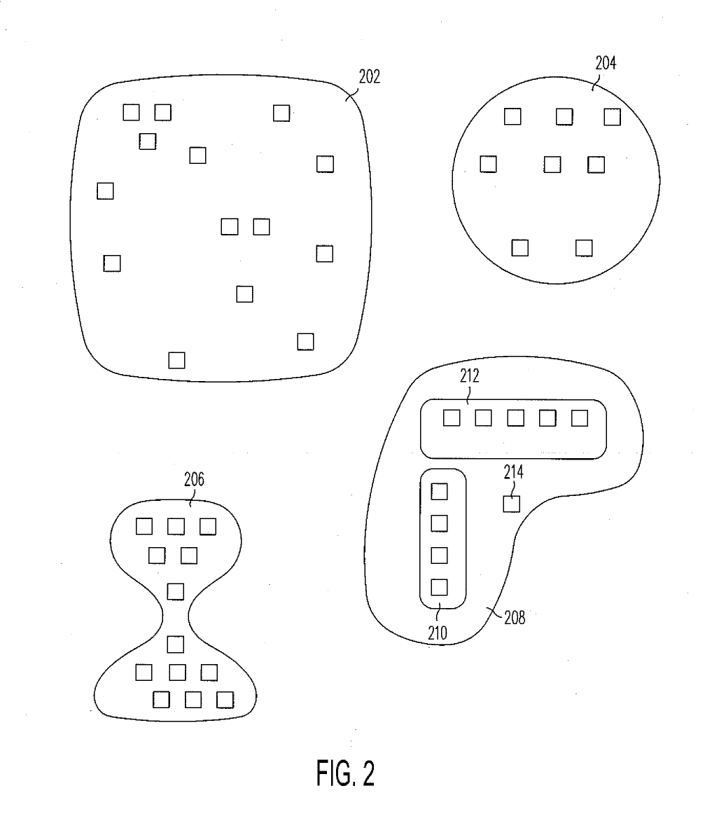

FIG. 2. shows examples of various groups of local merchants. In group 202, a relatively sparsely grouped set of merchants (shown as boxes) are all local, where the closest next merchant or cluster of merchants is far away. In group 204, a smaller cluster of merchants are grouped together to form a local affiliation. In group 206, a denser group of merchants form a local group, where the group is not a traditional shape (e.g., square, rectangle, circle, oval). Group 208 is formed of two sub-groups 210 and 212 and another merchant 214. Sub-groups 210 and 212 form their own local groups. So, merchants can be nested within larger groups to create multiple affiliations. Note that merchants, even though physically located within a group, may not actually be part of the group for purposes of the local marketing affiliation. For example, one or more merchants in group 212 may be affiliated with group 212, but not group 208. Similarly, one or more merchants in group 212 may not be affiliated with group 212, but is affiliated with group 208. This can be determined by individual merchants and/or the group.

Returning to FIG. 1, at step 102, the transaction details received from the first local merchant may include one or more of a merchant identifier, such as a merchant name or number, total amount of the transaction, information about individual items in the transaction, and a consumer identifier, such as a consumer ID, phone number, email address, account number, name, etc. The transaction details may be communicated from a merchant device, such as at a POS, when the consumer is ready to make a purchase. The consumer may present or communicate a consumer identifier to the merchant. Consumer information may also be communicated directly to the service provider, such as through a consumer device like a smart phone, tablet, or other device. The consumer may access an app or site of the service provider and enter login credentials, such as a user ID and password/PIN, to communicate consumer information. Consumer information may also be communicated directly from the consumer device, such as in the form of a device ID like a phone number.

The transaction details may be received when the consumer is at the POS of the first local merchant. However, transaction details may also be received at a remote location, such as at the consumer's home or office when the consumer is ready to make a purchase through a website of the first local merchant.

Once the transaction details are received by the service provider, the service provider accesses the consumer or user account at step 104. The service provider may search a database of accounts to determine whether an account exists corresponding to a user identified received by the service provider at step 102. The consumer account may include various information about the consumer, such as details about previous transactions or purchases made through the service provider and any account restrictions.

Next, at step 106, the service provider, based on the identity of the first local merchant, determines all local merchants affiliated with the first local merchant. For example, the service provider may again access a database to locate information, such as an account, of the first local merchant. The account information may include all affiliated local merchants. Merchants may sign up or opt in with the service provider so that the service provider can manage the local merchant marketing. A merchant may provide a listing or information about other merchants affiliated with the merchant. In this way, the service provider may be able to quickly determine whether a merchant is affiliated with any other merchants, and if so, which ones. For example, the service provider may access information about the first local merchant and see that there are seven other local merchants affiliated with the first local merchant.

The service provider may also determine, at step 108, any available incentives from the other affiliated merchants. Availability may include whether an incentive can be used or a purchase made with the incentive at the time of the purchase, whether the consumer's purchase qualifies for a particular incentive, and which merchants are offering incentives. For example, there may be Merchants 1, 2, 3, 6, and 7 all offering incentives for purchases made at the first local merchant, but only incentives from Merchants 1, 2, 3, and 6 are available for use that day. Of those incentives, only incentives from Merchants 1, 3, and 6 may be available to the consumer because of various limitations, such as the consumer's purchase did not qualify for any incentives from Merchant 2.

There may also be different types of incentives offered by the various affiliated merchants based on consumer purchase details, such as amount and/or type of purchase from the first local merchant. Incentives may also vary depending on who the consumer purchases from. For example, incentives available from purchases made at the first local merchant may be different than incentives available from purchases made from another local merchant, even though the purchases are similar in terms of amount and type. Incentives may also differ depending on whether the purchase from the first local merchant was made at the first local merchant's physical store or online.

Once all available incentives are determined, the service provider may determine, at step 110, which of those incentives are to provide to the consumer. This allows targeted incentives that are consumer-specific. For example, the service provider may determine, based on the consumer's previous purchases, that the consumer would not be interested in one or more of the available incentives and would be extremely interested in one or more other available incentives. The consumer may have never purchased coffee using the service or payment provider, but purchases snacks very frequently. In that case, a coffee purchase incentive at Merchant 1 may not be presented to the consumer, but instead an incentive at Merchant 6 (a donut shop) may be presented. In another example, the consumer may have never purchased women's clothing, but instead has purchased numerous electronic items. Here, incentives from a merchant selling only women's clothing may not be of interest to the consumer, but incentives from an electronics store may be of high interest. This step enables the service provider to filter incentives and present only relevant ones to the consumer. In one embodiment, step 110 may be skipped so that all incentives available to the consumer are provided, which may be suitable for smaller groups of merchants.

Next, the incentives are communicated at step 112. Communication can be to the consumer directly or to the first local merchant, who may then present the incentives to the consumer. In one embodiment, the service provider communicates selected incentives to a consumer device, such as a smart phone, which can be through email, text, or other means. The incentives may be displayed on the consumer device, such as via a list or other format. In another embodiment, the service provider may communicate selected incentives to the first local merchant, who then communicates the incentives to the consumer. This may be electronically to the consumer device, similar to the above, but the merchant may also present physical incentives, such as printed coupons, to the consumer. For example, the merchant may print out incentives received on a merchant device from the service provider.

After the consumer has received the incentives, a determination is made, at step 114, whether the consumer will be accepting any incentives. This determination may be communicated by the consumer and/or the first local merchant to the service provider, such as by either one tapping or selecting a link or button indicating no interest in any of the provided incentives. This indication is then transmitted electronically to the service provider. If the consumer does not wish to accept any incentives, the process may end with the consumer completing the purchase with the first local merchant as needed. For example, the consumer may make a payment to the first local merchant through the service provider or other known means, such as presenting the merchant with a credit card, debit card, check, and/or cash.

At step 114, the consumer may decide to accept one or more incentives, such as by selecting one or more incentives presented on the consumer device. The selection may be through a tap or other means. The consumer may also decide to accept an incentive to verbally communicating the desire to the first local merchant or by providing an indication through the merchant device.

If one or more incentives are or intend to be accepted, a determination is made, at step 116, whether the consumer wishes to pre-pay a purchase using the incentive. The consumer may wish to take the incentive(s) with him after leaving the first local merchant. For example, the consumer may not have decided to actually make a purchase using the incentive, but still wants the incentive for a possible purchase. The incentive may be for 30% off a purchase at a coffee shop, but the consumer may be sure he wants any coffee. He may, but has not yet decided. So, the consumer would prefer to have the incentive for possible later use, but not commit to the purchase at the present time. In that case, the consumer may finish the payment process with the first local merchant and take any desired incentives with him. The incentives may be stored on the consumer device or physical coupons given to the consumer by the merchant.

If the consumer decides to use the incentive, the consumer may take the incentive and present it to a second local merchant, either at the second local merchant store or online site. The second local merchant may then process the incentive, such as through the service provider, to make a purchase using the incentive. After the consumer pays the second local merchant, a portion of the payment may be debited from the second local merchant account and credited to an account of the first local merchant as a cash bonus to the first local merchant. The cash bonus may also be credited directly into the first local merchant account by the service provider, and the account of the second local merchant credited with the purchase amount minus the cash bonus account. The incentive may contain information sufficient to identify that the incentive came from the first local merchant so that the first local merchant can be credited with the “referral.” In this embodiment, the first local merchant receives a cash bonus when an incentive presented through the first local merchant is used. The amount of the cash bonus may be fixed or depend on various factors, such as the purchase price or total money spent at the second local merchant. In other embodiments, no cash bonus is debited or credited.

If the consumer wishes to pre-pay a purchase using the incentive(s), the payment may be processed at step 118. Payment may be through the first local merchant store or site. The consumer may pay combine the first local merchant purchase with the purchase using the incentive from a second local merchant, or the payment may be made separately. In either case, the consumer makes the payment to the first local merchant for a purchase from the second local merchant. In one embodiment, the payment is made through the service or payment provider, such as by communicating the appropriate information to the service provider. This information may include transaction details using the incentive, such as information about the second local merchant, incentive information, and item or purchase information. Using this information, the service provider may then process the payment.

In one example, the service provider debits the total purchase amount (which includes both the purchase with the first local merchant and the purchase using the incentive for the second local merchant) from the consumer's account with the service provider. The account of the first local merchant may then be credited the total amount minus the amount attributed to the purchase from the second local merchant plus any referral or bonus due to the first local merchant for the second local merchant purchase.

In another example, the service provider debits the purchase amount for purchases with the first local merchant from the consumer's account and credits that amount to the account of the first local merchant. The account of the first local merchant may also be credited with the referral or bonus amount if applicable. The account of the consumer is also debited an amount equal to the purchase from the second local merchant using the incentive. The purchase amount may be credited to an account of the second local merchant minus any applicable referable or bonus payments. As described above, the incentive may include an identifier that identifies the first local merchant as the one who provided the consumer with the incentive, either directly or indirectly.

After payment is processed, the consumer and/or the second local merchant may be notified at step 120. The service provider may send a receipt or other confirmation to the consumer device, such as in the form of a barcode/QR code, electronic receipt, transaction number, etc. The service provider may also send a notification to the second local merchant confirming that a payment was processed from the consumer to the second local merchant, identifying the amount, the purchase, the consumer, and/or any other suitable information.

The consumer may then receive or pick up the purchase from the second local merchant, either at the physical store or through shipping via the online site. The consumer may present proof of purchase to the second local merchant so that the second local merchant may release the purchase to the consumer. For example, the consumer may show a receipt or QR code to the second local merchant, who may then retrieve information or scan the QR code to confirm payment. The consumer may also simply provide an identity document or number, which the second local merchant uses to retrieve information about the purchase. Using the coffee example, the consumer may show a QR code on the user smart phone to a clerk at the coffee store (the second local merchant). The clerk scans the QR code and receives confirmation on the merchant device that payment was made for a large frozen coffee. The coffee is then given to the consumer to enjoy. Thus, the consumer is able to simply show some sort of purchase confirmation information to the second local merchant and receive the purchased item(s) quickly and easily and at a discount.

Using this type of local merchant marketing, merchants affiliated only by physical location may enjoy cross-marketing to the benefit of multiple parties. The first local merchant may receive a referral bonus, either if/when the incentive is used or even if the incentive is not used. If no incentive is used, the first local merchant may receive future purchases, from consumers receiving incentives from other local merchants for use with the first local merchant. The second local merchant receives a sale or purchase it may not otherwise have received because the consumer is presented with an incentive, which may be consumer-specific, while in close proximity to the second local merchant. The consumer benefits from being able to make a purchase at a discount and not have to make a separate trip or purchase to do so.

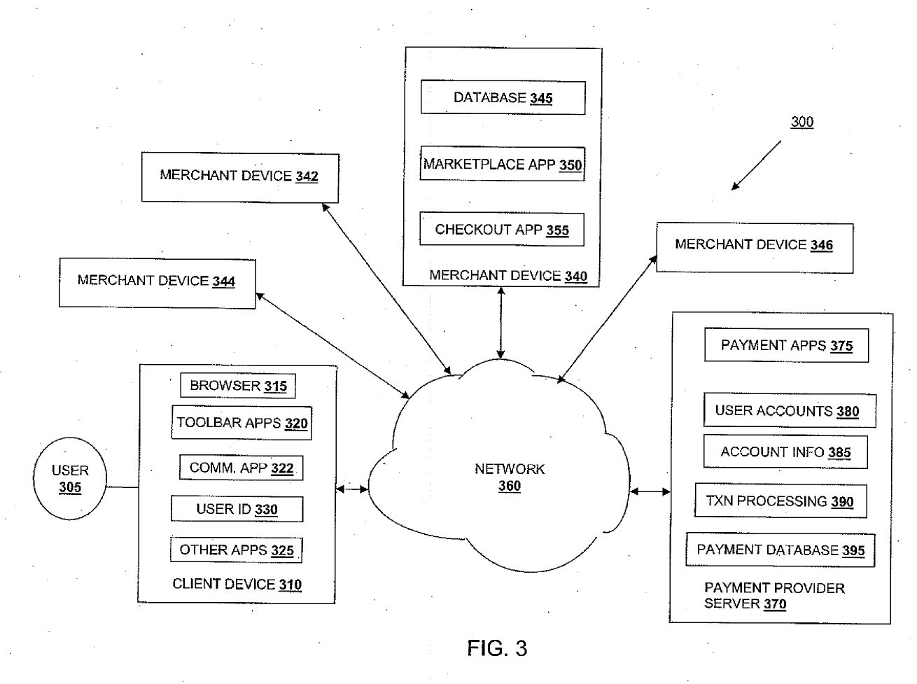

FIG. 3 is a block diagram of a networked system 300 configured to handle a financial transaction between a payment recipient (e.g., merchant, content provider, etc.) and a payment sender (e.g., user or consumer), such as described above, in accordance with an embodiment of the invention. System 300 includes a user device 310, a plurality of merchant servers or devices 340, 342, 344, 346, and a payment provider server 370 in communication over a network 360. Payment provider server 370 may be maintained by a payment provider, such as PayPal, Inc. of San Jose, Calif. A user 305, such as the sender or consumer, utilizes user device 310 to perform a payment transaction with one or more merchant devices 340, 342, 344, 346 using payment provider server 370. Note that more or less merchant devices are possible, as they represent merchants within a local affiliated group as discussed above and can be any suitable number.

User device 310, merchant devices 340, 342, 344, 346, and payment provider server 370 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 300, and/or accessible over network 360.

Network 360 may be implemented as a single network or a combination of multiple networks. For example, in various embodiments, network 360 may include the Internet or one or more intranets, landline networks, wireless networks, and/or other appropriate types of networks.

User device 310 may be implemented using any appropriate hardware and software configured for wired and/or wireless communication over network 360. For example, in one embodiment, the user device may be implemented as a smart phone, personal digital assistant (PDA), laptop computer, PC, and/or other types of computing devices capable of transmitting and/or receiving data, such as an iPad™ from Apple™.

User device 310 may include one or more browser applications 315 which may be used, for example, to provide a convenient interface to permit user 305 to browse information available over network 360. For example, in one embodiment, browser application 315 may be implemented as a web browser configured to view information available over the Internet or access a website of the payment provider. User device 310 may also include one or more toolbar applications 320 which may be used, for example, to provide client-side processing for performing desired tasks in response to operations selected by user 305. In one embodiment, toolbar application 320 may display a user interface in connection with browser application 315 as further described herein.

User device 310 may further include other applications 325, such as mobile Apps, as may be desired in particular embodiments to provide desired features to user device 310. For example, other applications 325 may include security applications for implementing client-side security features, programmatic client applications for interfacing with appropriate application programming interfaces (APIs) over network 360, or other types of applications. Applications 325 may also include apps for email, texting, voice and IM applications that allow user 305 to send and receive emails, calls, and texts through network 360, as well as applications or apps that enable the user to communicate, place orders, and make payments through the payment provider as discussed above. User device 310 includes one or more user identifiers 330 which may be implemented, for example, as operating system registry entries, cookies associated with browser application 315, identifiers associated with hardware of user device 310, or other appropriate identifiers, such as used for payment/user/device authentication. In one embodiment, user identifier 330 may be used by a payment service provider to associate user 305 with a particular account maintained by the payment provider as further described herein. A communications application 322, with associated interfaces, enables user device 310 to communicate within system 300.

Merchant device 340 may be maintained, for example, by a local merchant or seller offering various products and/or services in exchange for payment to be received over network 360 or in person. Generally, merchant device 340 may be maintained by anyone or any entity that receives money, which includes charities as well as retailers and restaurants. Merchant device 340 includes a database 345 identifying available products and/or services (e.g., collectively referred to as items) which may be made available for viewing and purchase by user 305 and can be at the physical site of the merchant or remote, such as a server. Accordingly, merchant device 340 also includes a marketplace application 350 which may be configured to serve information over network 360 to browser 315 of user device 310. In one embodiment, user 305 may interact with marketplace application 350 through browser applications over network 360 in order to view various products, food items, or services identified in database 345.

Merchant device 340 also includes a checkout application 355 which may be configured to facilitate the purchase by user 305 of goods or services identified by marketplace application 350. Checkout application 355 may be configured to accept payment information from or on behalf of user 305 through payment service provider server 370 over network 360. For example, checkout application 355 may receive and process a payment confirmation from payment service provider server 370, as well as transmit transaction information to the payment provider and receive information from the payment provider (e.g., a transaction ID). Checkout application 355 may also be configured to dispense or communicate incentives from other local merchants.

Merchant devices 342, 344, 346 are similar to merchant device 340, but represent devices from different merchants affiliated by location, as discussed above. As such, merchant devices 340, 342, 344, 346 may receive and process purchases using incentives dispensed at other merchant locations, as discussed above.

Payment provider server 370 may be maintained, for example, by an online payment service provider which may provide payment between user 305 and the operator of merchant devices 340, 342, 344, 346. In this regard, payment provider server 370 includes one or more payment applications 375 which may be configured to interact with user device 310 and/or merchant devices 340, 342, 344, 346 over network 360 to facilitate the purchase of goods or services by user 305 of first user device 310 using incentives provided by local merchants for use at other local merchants.

Payment provider server 370 also maintains a plurality of user accounts 380, each of which may include account information 385 associated with individual users and merchants. For example, account information 385 may include private financial information of users of devices such as account numbers, passwords, device identifiers, user names, phone numbers, credit card information, bank information, or other financial information which may be used to facilitate online transactions by user 305. Account information 385 may also include incentives provided by various local merchants, as discussed above. Advantageously, payment application 375 may be configured to interact with merchant devices 340, 342, 344, 346 on behalf of user 305 during a transaction with checkout application 355 to track and manage purchases made by users and whether incentives are used, and if so, where the incentives came from.

A transaction processing application 390, which may be part of payment application 375 or separate, may be configured to receive information from a user device and/or merchant devices 340, 342, 344, 346 for processing and storage in a payment database 395. Transaction processing application 390 may include one or more applications to process information from user 305 and/or one or more merchants for processing a payment from the user through a user device while on a website or app as described herein. As such, transaction processing application 390 may store details of an order and associate the details with a purchase or incentive identifier for individual users and merchants. Payment application 375 may be further configured to determine the existence of and to manage accounts for user 305, as well as create new accounts if necessary, such as the set up, management, and use of purchase identifiers.

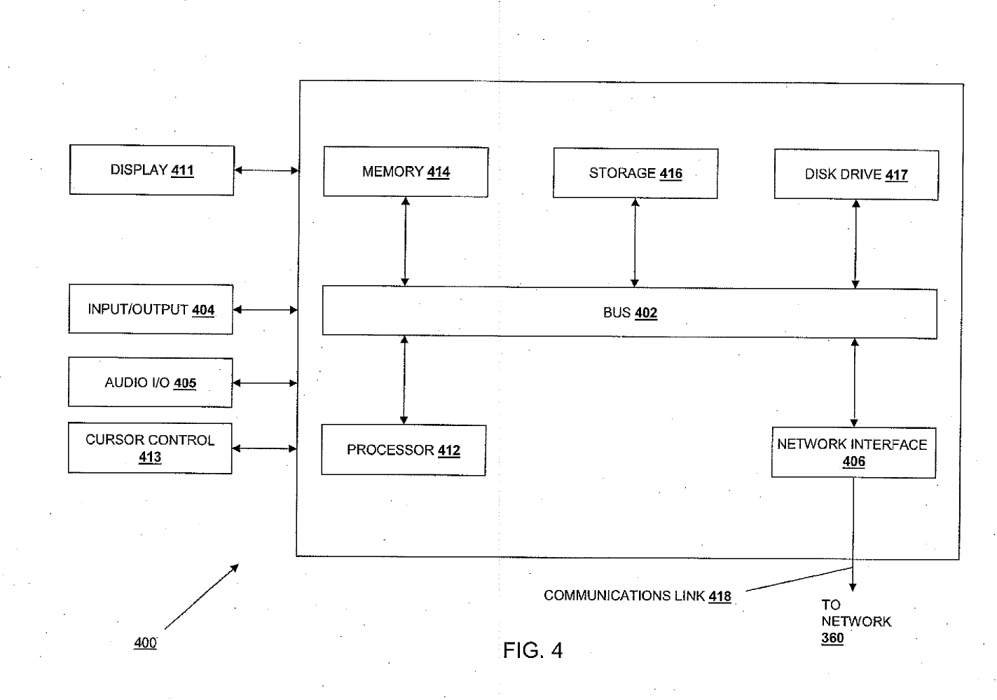

FIG. 4 is a block diagram of a computer system 400 suitable for implementing one or more embodiments of the present disclosure. In various implementations, the user device may comprise a personal computing device (e.g., a personal computer, laptop, smart phone, PDA, Bluetooth device, key FOB, badge, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 400 in a manner as follows.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons or links, etc., and sends a corresponding signal to bus 402. I/O component 404 may also include an output component, such as a display 411 and a cursor control 413 (such as a keyboard, keypad, mouse, etc.). An optional audio input/output component 405 may also be included to allow a user to use voice for inputting information by converting audio signals. Audio I/O component 405 may allow the user to hear audio. A transceiver or network interface 406 transmits and receives signals between computer system 400 and other devices, such as another user device, a merchant server, or a payment provider server via network 460. In one embodiment, the transmission is wireless, although other transmission mediums and methods may also be suitable. A processor 412, which can be a micro-controller, digital signal processor (DSP), or other processing component, processes these various signals, such as for display on computer system 400 or transmission to other devices via a communication link 418. Processor 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor 412 and other components by executing one or more sequences of instructions contained in system memory component 414. Logic may be encoded in a computer readable medium, which may refer to any medium that participates in providing instructions to processor 412 for execution. Such a medium may take many forms, including but not limited to, non-volatile media, volatile media, and transmission media. In various implementations, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 418 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure.

What is claimed is:

1. A system comprising:
a memory storing account information for a plurality of users, wherein the account information comprises a user identifier, user transaction history, and incentives for use at locally affiliated merchants;
a processor operable for:
receiving transaction details for a purchase at a first local merchant;
accessing, by a payment provider, an account of a user with the payment provider;
determining one or more local merchants affiliated with the first local merchant;
determining available incentives for use with the one or more local merchants;
communicating one or more of the available incentives to the first local merchant or the user; and
processing a purchase request for a payment to a second local merchant using one or more incentives obtained through the purchase at the first local merchant.

2. The system of claim 1, wherein the processor is further operable for determining from the one or more available incentives at least one incentive specific to the user based on the user transaction history.

3. The system of claim 1, wherein the processing comprises crediting an account of the first local merchant with a cash bonus and debiting an account of the second local merchant with the cash bonus.

4. The system of claim 1, wherein the processing is during the purchase at the first local merchant.

5. The system of claim 1, wherein the one or more local merchants are affiliated with the first local merchant only by location.

6. The system of claim 1, wherein the one or more of the available incentives is communicated to a user device.

7. The system of claim 1, wherein the processor is further operable for notifying the second local merchant and/or the user when the purchase request is completed.

8. The system of claim 1, wherein incentives are provided to the payment provider by the first local merchant and the one or more local merchants locally affiliated with the first local merchant and each other.

9. A method for performing a payment transaction, comprising:
receiving, electronically by a processor of a payment provider, transaction details for a purchase at a first local merchant;
accessing, by the processor, an account of a user with the payment provider;
determining, by the processor, one or more local merchants affiliated only locally by location with the first local merchant;
determining, by the processor, available incentives for use with the one or more local merchants;
communicating, electronically by the processor, one or more of the available incentives to the first local merchant or the user; and
processing, by the processor, a purchase request for a payment to a second local merchant using one or more incentives obtained through the purchase at the first local merchant.

10. The method of claim 9, further comprising determining from the one or more available incentives at least one incentive specific to the user based on the user transaction history.

11. The method of claim 9, wherein the processing comprises crediting an account of the first local merchant with a cash bonus and debiting an account of the second local merchant with the cash bonus.

12. The method of claim 9, wherein the processing is during the purchase at the first local merchant.

13. A non-transitory machine-readable medium comprising a plurality of machine-readable instructions which when executed by one or more processors of a server are adapted to cause the server to perform a method comprising:
receiving, by a payment provider, transaction details for a purchase at a first local merchant;
accessing an account of a user with the payment provider;
determining one or more local merchants affiliated with the first local merchant;
determining available incentives for use with the one or more local merchants;
communicating one or more of the available incentives to the first local merchant or the user; and
processing a purchase request for a payment to a second local merchant using one or more incentives obtained through the purchase at the first local merchant.

14. The non-transitory machine-readable medium of claim 13, wherein the method further comprises determining from the one or more available incentives at least one incentive specific to the user based on the user transaction history.

15. The non-transitory machine-readable medium of claim 13, wherein the processing comprises crediting an account of the first local merchant with a cash bonus and debiting an account of the second local merchant with the cash bonus.

16. The non-transitory machine-readable medium of claim 13, wherein the processing is during the purchase at the first local merchant.

17. The non-transitory machine-readable medium of claim 13, wherein the one or more local merchants are affiliated with the first local merchant only by location.

18. The non-transitory machine-readable medium of claim 13, wherein the one or more of the available incentives is communicated to a user device.

19. The non-transitory machine-readable medium of claim 13, wherein the method further comprises notifying the second local merchant and/or the user when the purchase request is completed.

20. The non-transitory machine-readable medium of claim 13, wherein incentives are provided to the payment provider by the first local merchant and the one or more local merchants locally affiliated with the first local merchant and each other.
